(19) United States
(12) Patent Application Publication
(10) Pub. No.: US 2011/0015553 A1
(43) Pub. Date: Jan. 20, 2011

(54) ADJUSTABLE LEG MASSAGER

(75) Inventor: Yuan-Chuen Chen, Wai Zhong Village (TW)

Correspondence Address: Yen Jung Sung, 30-47 37 St., Astoria, NY, 11103, US

(73) Assignee: HSIN HAO HEALTH MATERIALS CO., LTD., Fan She Village (TW)

(21) Appl. No.: 12/503,836

(22) Filed: Jul. 16, 2009

(51) Int. Cl. A61H 1/00; A61H 15/00; A61H 7/00

(52) U.S. Cl. 601/46; 601/112; 601/151

(57) ABSTRACT

An adjustable leg massager has a massage base, two connecting joints and a rotatable massage unit. The massage base has two symmetrical vertical openings at a front face, a plurality of first massage airbags disposed in the openings, and a first cover covering the first massage airbags. The two connecting joints have an upper joint portion and a lower joint portion pivoted together. A stop is disposed at an outer edge of the upper joint portion and adjacent to the pivoted position. The rotatable massage unit has two massaging sections corresponding to the vertical openings of the massage base, a plurality of second massage airbags disposed in the massaging sections, and a second cover covering the second massage airbags. The massage airbags have a plurality of individual massage regions and each massage region is connected with an outlet.

### BACKGROUND OF THE INVENTION

1. Field of the Invention

The present invention relates to a leg massager, and more particularly to an adjustable leg massager, which utilizes connecting joints to connect a massage base and a rotatable massage unit so that the rotatable massage unit can be rotated to provide a massage to different leg regions.

2. Description of the Related Art

Modern life is causing more and more people to suffer from high stress. A massage is one of the more common relaxation methods, which can help to induce relaxation and rest. In addition, after long periods of standing up, or walking, running, or bicycling exercises, a user's leg muscles suffer fatigue. In order to reduce muscular pain, leg massagers are very popular relaxation products. As shown in FIG. 11, a prior art leg massager has a massage base 40 with a rectangular shape, and the top face of the massage base 40 has two symmetric openings 41. The two openings 41 both respectively have a massaging section 42, and each massaging section 42 has a massage airbag 43 and an outlet 421 for connection to an air tube 431. The massaging airbags 43 are disposed in the openings 41 with a U shape, and a cover 44 is overlaid on top of the massage airbags 43. During operation, a user places his or her two legs in the two openings 41, and then the massage airbags 43 are inflated to massage the legs. However, the prior art leg massager has following drawbacks:

1. The massage base 40 has the massage airbags 43 in two separate openings 41; while the massage is being performing, the massaging sections 41 can only provide a massage to certain regions of the user's leg. In order to massage the user's calves or upper legs, the user needs to move the massager to different positions and cannot enjoy the massage on the calves and upper legs at the same time.

2. The massage airbags 43 are disposed in the openings 41 of the massaging base 40 with a U shape; when the massaging airbags are inflated, they rise from the center region repeatedly, which may cause localized discomfort.

Therefore, it is desirable to provide an adjustable leg massager to mitigate and/or obviate the aforementioned problems.

### SUMMARY OF THE INVENTION

A main objective of the present invention is to provide an adjustable leg massager.

In order to achieve the above mentioned objective, the adjustable leg massager comprises: a massage base, two connecting joints and a rotatable massage unit. The massage base has two symmetrical vertical openings at its front face, with a plurality of first massage airbags disposed in the openings, and a first cover covers the first massage airbags. The internal space of the massage base has tubes connected to the massage airbags for deflating and inflating purposes and also includes vibrators at predetermined positions. The two connecting joints each respectively comprises an upper joint portion and a lower joint portion pivoted together, and the upper and lower joint portions both respectively have a plurality of eyelets. A stop is disposed at an outer edge of the upper joint portion and adjacent to the pivoted position. The rotatable massage unit has two massaging sections, each of which corresponds to a respective vertical opening of the massage base. A plurality of second massage airbags are disposed in the massaging sections, and a second cover covers the second massage airbags. The rotatable massage unit has tubes connected to the second massage airbags for deflating and inflating purposes and vibrators at predetermined positions. The massage airbags have a plurality of individual massage regions, and each massage region is connected with a corresponding outlet. With various inflating sequences, the massage airbags provide a massage at different angles and pressures. The covers are made of a supple, durable material, such as leather or cloth. A massage pad disposable between the massage airbags and the cover provides raised bumps on the surface of the cover to enhance massaging results.

The massage base has the first massage airbags in the two openings, and the cover covers the first massage airbags so that the massage base provides two containment spaces for the soles and lower portions of the calves. The top end of the massage base is connected to the rotatable massage unit via wires, and the two connecting joints are respectively and closely disposed on the massage base and the rotatable massage unit. The lower joint portions are screwed onto a top outer edge of the massage base with the eyelets, and the upper joint portions are screwed onto the bottom outer edge of the rotatable massage unit with the eyelets. With the hinge mechanism provided by the upper and lower joint portions the rotatable massage unit can be rotated upward. Since the massaging sections of the rotatable massage unit both have the second massage airbags and the cover covering the second massage airbags, the rotatable massage unit provides two containment spaces for the user's calves or upper legs.

With the above-mentioned structure, the present invention provides the following benefits: 1. The massage base 10 and the rotatable massage unit are connected by the connecting joints, and so the rotatable massage unit is able to be rotated around the connecting joint; therefore, with different adjustments, the rotatable massage unit can provide a massage to two different leg portions so that the soles, calves and upper legs can all be affected by the massaging movements. 2. The first and second massage airbags have the individual massage regions, and with the various inflation sequences of the massage regions, the first and second massage airbags generate a pressing massage movement and a rubbing massage movement and prevents excessive massaging on a single area of the legs.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is a perspective view of another embodiment of the present invention.

FIG. 3 is a detail view of a connecting joint shown in FIG. 2 according to the present invention.

FIG. 4 is an exploded view of the present invention.

FIG. 5 is a side view of a massage airbag according to the present invention.

FIG. 6 is a schematic drawing of an operational status of the present invention.

FIG. 7 is a schematic drawing of another operational status of the present invention.

FIG. 8 is a schematic drawing of the inflating sequence of massage airbags according to the present invention.

FIG. 9 is another schematic drawing of the inflating sequence of the massage airbags according to the present invention.

FIG. 10 is an exploded view of a massager with a massaging pad according to the present invention.

FIG. 11 is an exploded view of a prior art device.

### DETAILED DESCRIPTION OF THE PREFERRED EMBODIMENT

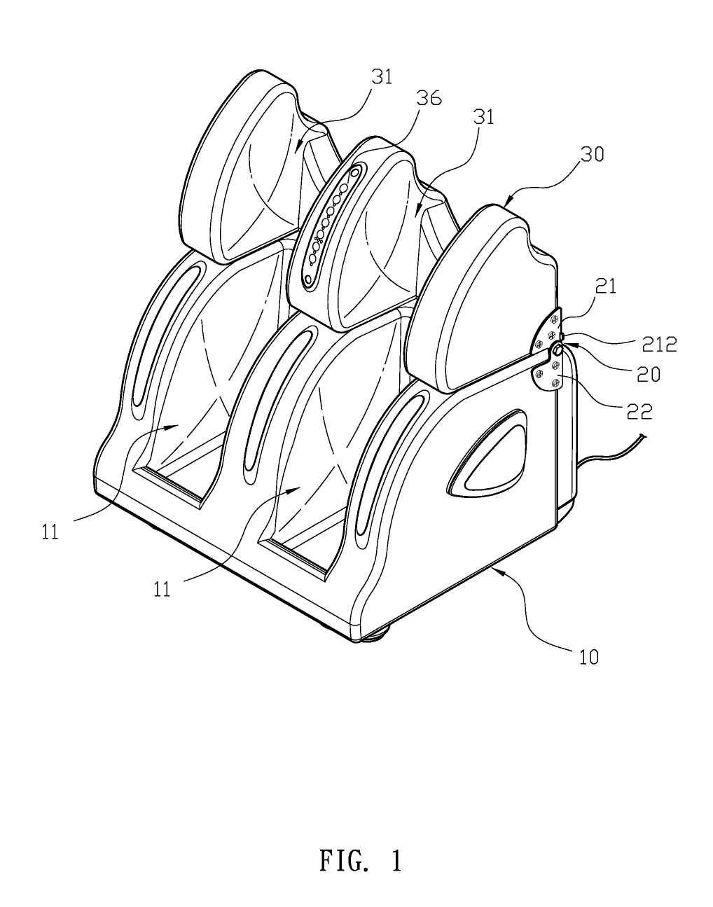

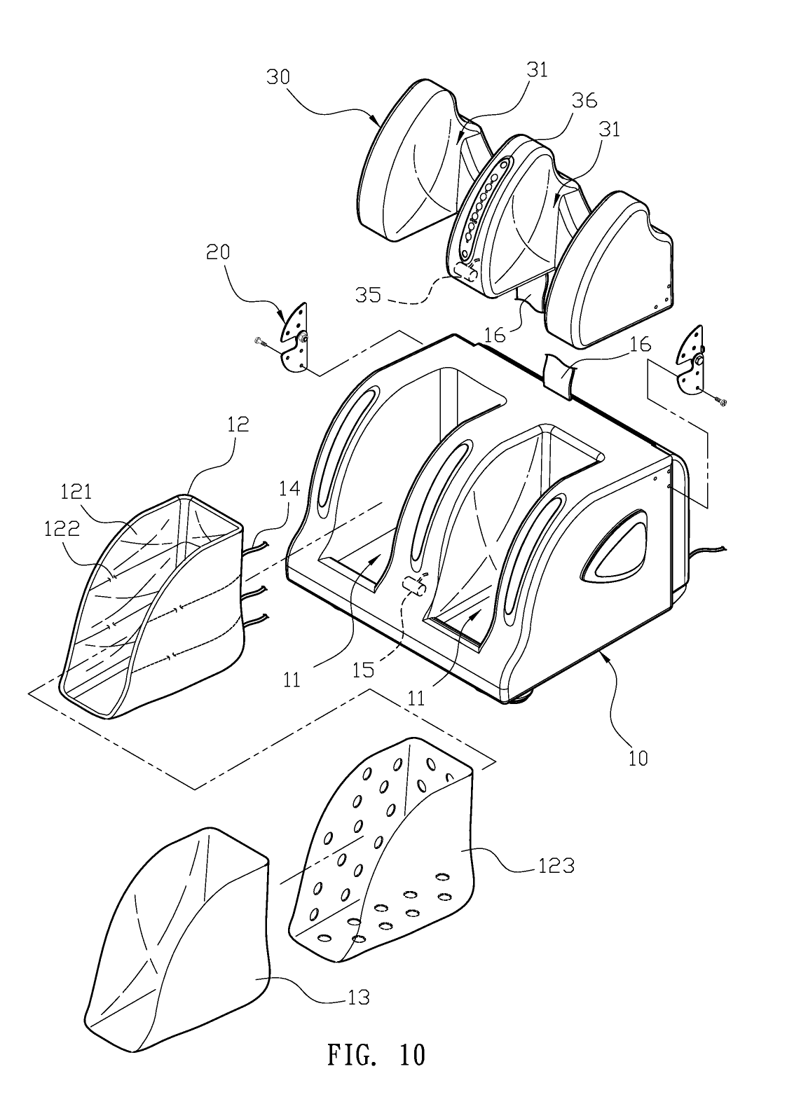

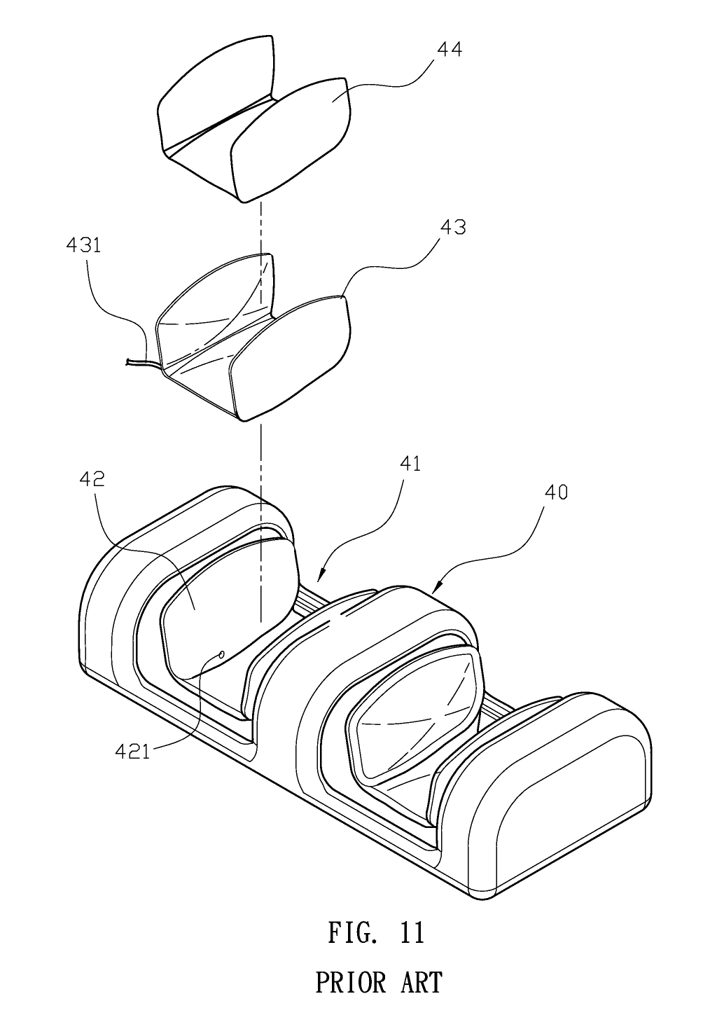

Please refer to FIG. 1 to FIG. 4. An embodiment adjustable leg massager comprises: a massage base 10, two connecting joints 20 and a rotatable massage unit 30. The massage base 10 has two symmetrical vertical openings 11 at its front face, with a plurality of first massage airbags 12 disposed in the openings 11, and a first cover 13 covers the first massage airbags 12. The internal space of the massage base 10 has tubes connected to the massage airbags 12 for deflating and inflating purposes and also includes vibrators 15 at predetermined positions. The two connecting joints 20 each respectively comprises an upper joint portion 21 and a lower joint portion 22 pivoted together, and the upper and lower joint portions 21, 22 both respectively have a plurality of eyelets 211, 221. A stop 212 is disposed at an outer edge of the upper joint portion 21 and adjacent to the pivoted position. The rotatable massage unit 30 has two massaging sections 31, each of which corresponds to a respective vertical opening 11 of the massage base 10. A plurality of second massage airbags 32 are disposed in the massaging sections 31, and a second cover 33 covers the second massage airbags 32. The rotatable massage unit 30 has tubes 34 connected to the second massage airbags 32 for deflating and inflating purposes and vibrators 35 at predetermined positions. The massage airbags 12, 32 have a plurality of individual massage regions 121, 321, and each massage region is connected with a corresponding outlet 122, 322. With various inflating sequences, the massage airbags 12, 32 provide a massage at different angles and pressures. The covers 13, 33 are made of a supple, durable material, such as leather or cloth. Please refer to an embodiment shown in FIG. 10. A massage pad 123 disposable between the massage airbags 12, 32 and the cover 13, 33, provides raised bumps on the surface of the cover 13, 33 to enhance massaging results.

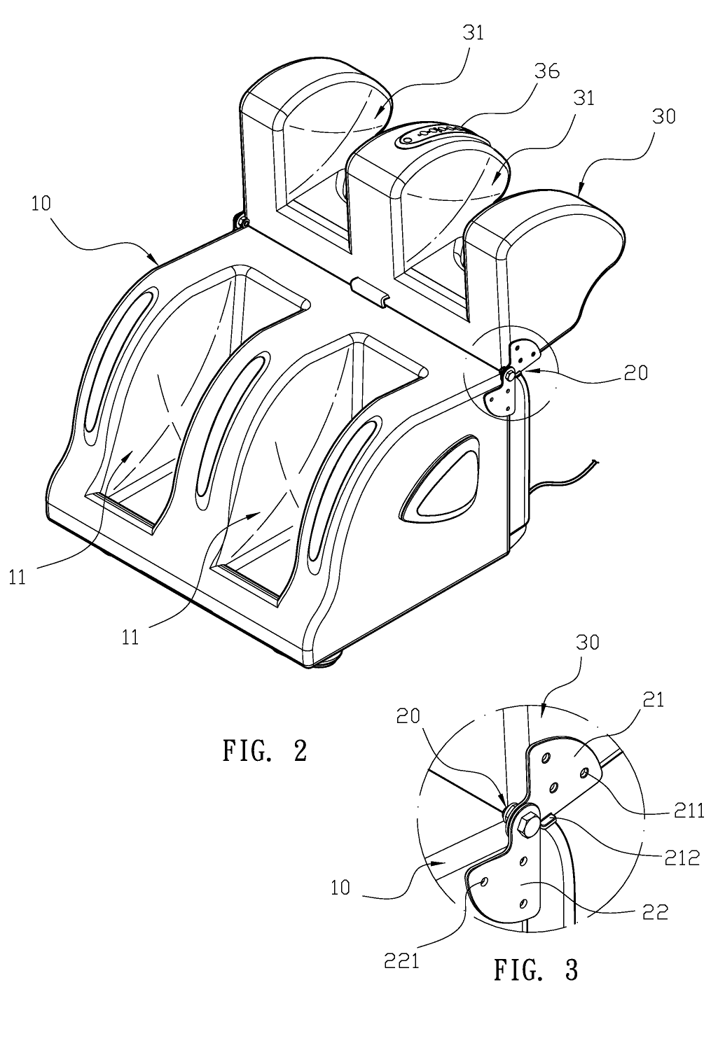

Please refer again to FIG. 2 to FIG. 5. The massage base 10 has the first massage airbags 12 in the two openings 11, and the cover 13 covers the first massage airbags 12 so that the massage base 10 provides two containment spaces for the soles and lower portions of the calves. The top end of the massage base 10 is connected to the rotatable massage unit 30 via wires 16, and the two connecting joints 20 are respectively and closely disposed on the massage base 10 and the rotatable massage unit 30. The lower joint portions 22 are screwed onto a top outer edge of the massage base 10 with the eyelets 221, and the upper joint portions 21 are screwed onto the bottom outer edge of the rotatable massage unit 30 with the eyelets 211. With the hinge mechanism provided by the upper and lower joint portions 21, 22, the rotatable massage unit 30 can be rotated upward. Since the massaging sections 31 of the rotatable massage unit 30 both have the second massage airbags 32 and the cover 33 covering the second massage airbags 32, the rotatable massage unit 30 provides two containment spaces for the user's calves or upper legs.

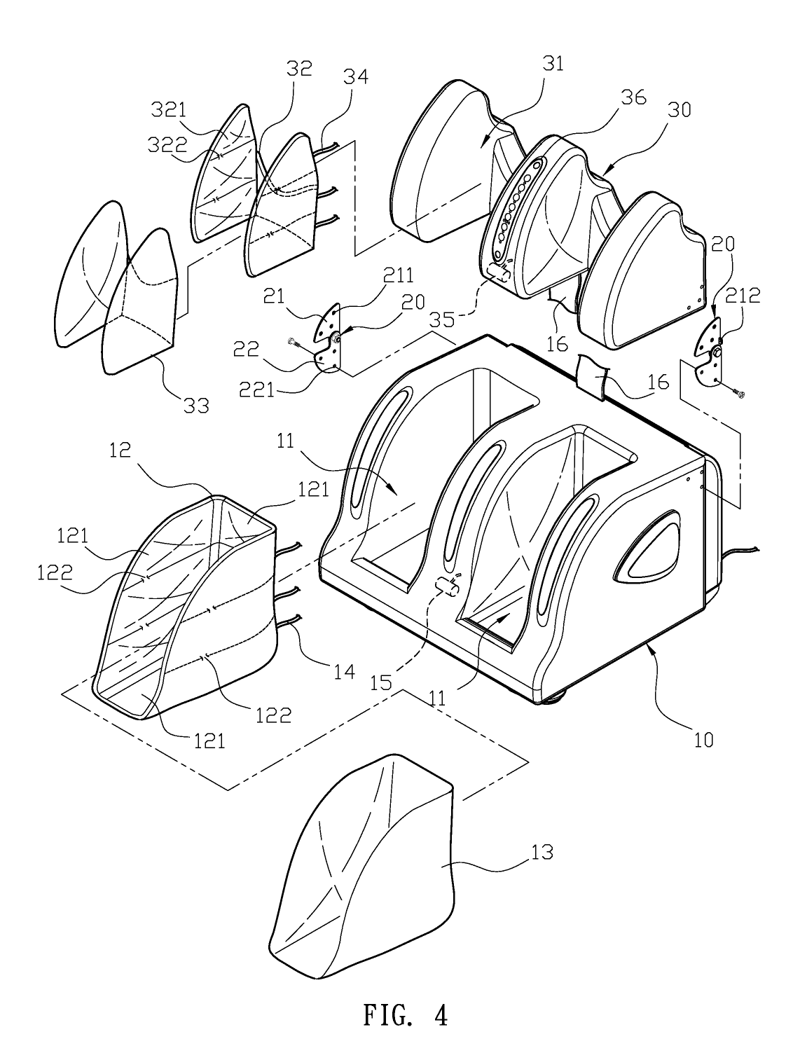

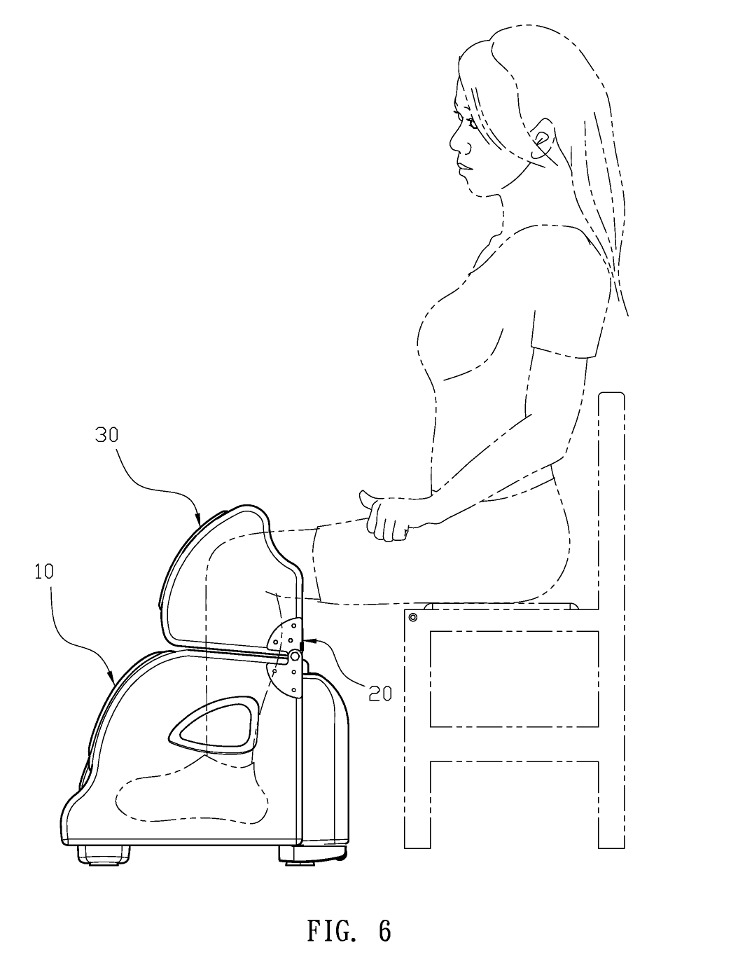

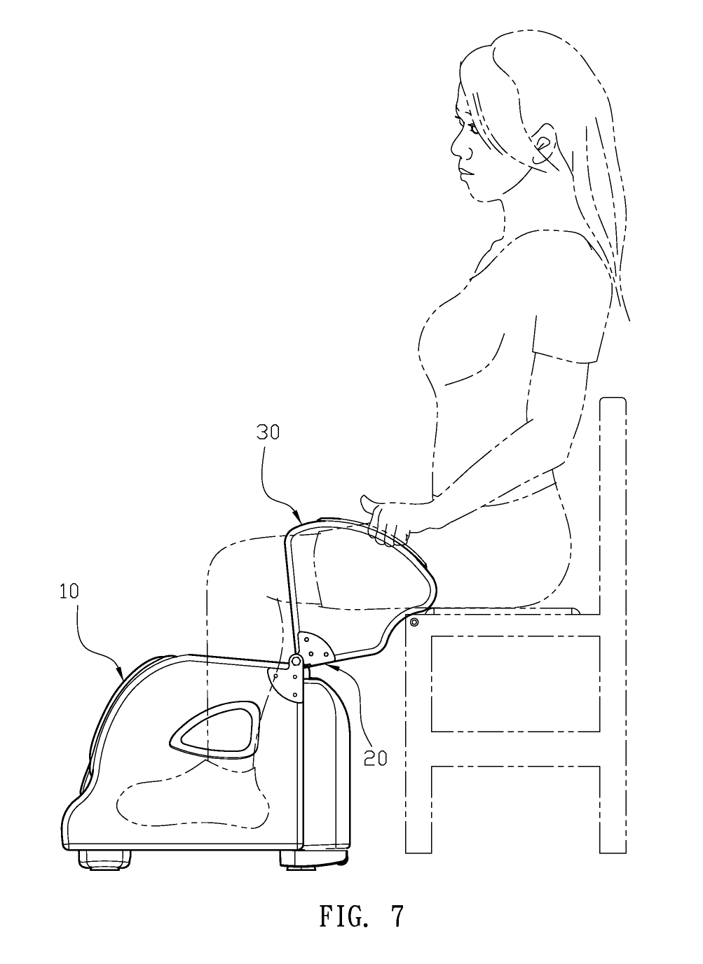

For actual operations, please refer to FIG. 6 and FIG. 7, with further reference to FIG. 3 and FIG. 4. The massage base 10 is used for a user to place his or her two feet in the two openings 11. The openings 11 surround the soles and the lower portions of the calves, and the upper portion of the calves are placed in the massaging section 31 of the rotatable massage unit 30. A controller 36 is used for controlling the massage movements, and the controller 36 may be a remote control unit or a control panel. The control panel may be disposed at a center raised section between the two openings 11 of the massage base 10 or at a center raised section between the two massaging sections 31 of the rotatable massage unit 30. While using the controller 36 to execute the massage movements, the first and second massage airbags 12, 32 are both continuously inflated and deflated by the tubes 14, 34, which action provides a varying pressure to the legs as part of the massage. When the rotatable massage unit 30 is not rotated upward, it directly presses onto the upper portion of the calves and provides a massage. Alternatively, when the rotatable massage unit 30 is rotated upward around the connecting joint 20, the rotatable massage unit 30 can be rotated to a position below the upper legs so that the second massage airbags 32 in the massaging section 31 can apply pressure to the upper legs for massage purposes. As indicated, the stop 212 is disposed at an outer edge of the upper joint portion 21 and adjacent to the pivoted position the connecting joint 20. When the rotatable massage unit 30 is rotated upward, the stop 212 pushes against the outer edge of the lower joint portion 22 to limit the maximum rotational angle of the rotatable massage unit 30.

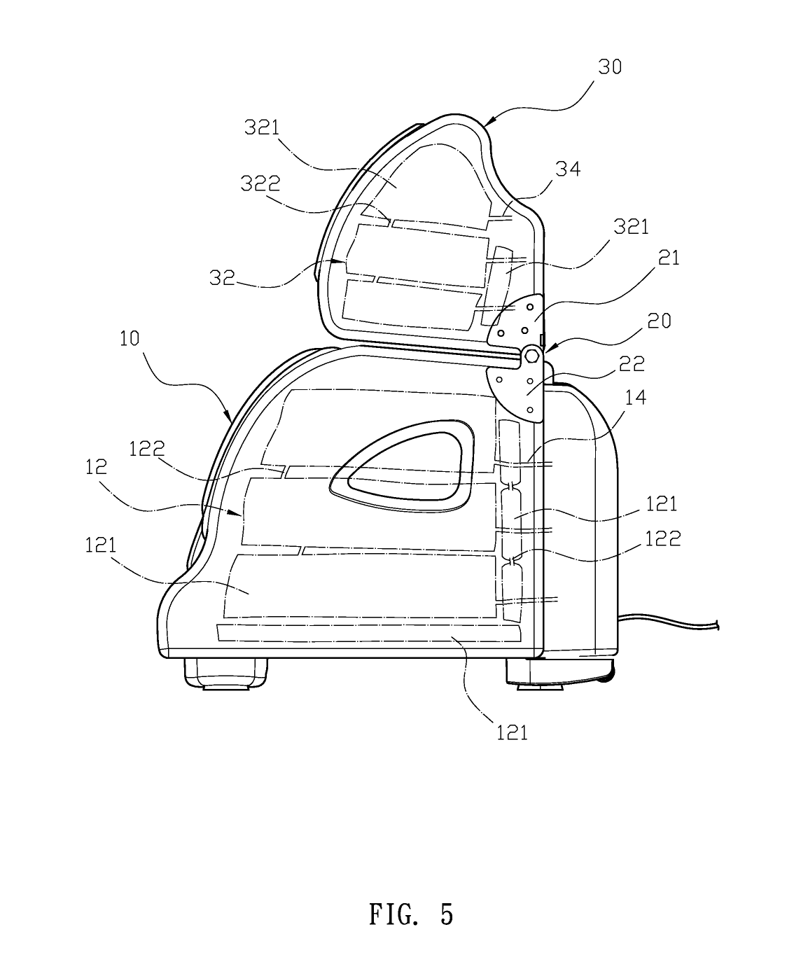

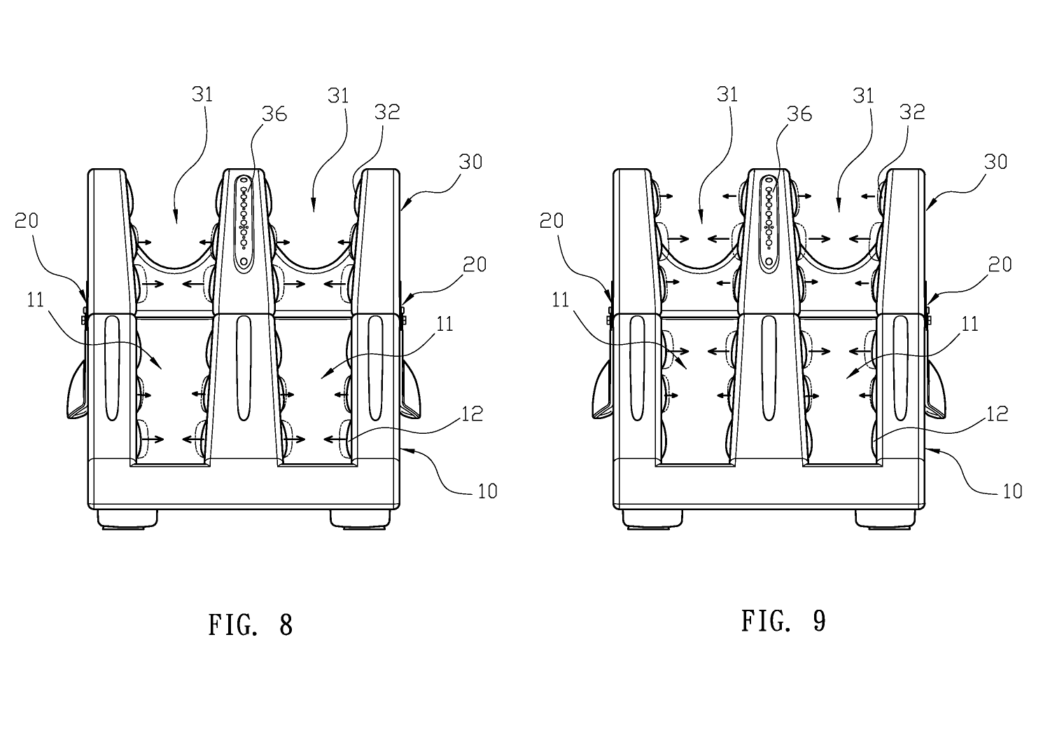

For an embodiment inflation and deflation procedure of the first and second massage airbags 12, 32, please refer to FIGS. 8 and 9. With further reference to FIG. 5, the first and second massage airbags 12, 32 disposed in the massage base 10 and the rotatable massage unit 30 are both connected to the tubes 14, 34, and an air pump (not shown) is connected to the other end of the tubes 14, 34 and used for providing air. Both the first and second massage airbags 12, 32 respectively have a plurality of massage regions 121, 321 and outlets 122, 322 connected to each of two adjacent massage regions 121, 321. Each massage region 121, 321 is independently connected to a tube 14, 34. While the massage is being performed, the first and second massage airbags 12, 32 are inflated with one of the massage regions 121, 321, the inflated massage regions 121, 321 applying a massage to the legs. The outlets 122, 322 guide the air into the adjacent massage regions 121, 321 so the adjacent massage regions 121, 321 generate a delayed massage movement. Therefore, with different inflation positions, the first and second massage airbags 12, 32 generate various massage movement sequences, which are similar to pressing and rubbing movements so that the user experiences a massage similar to the one performed by a real masseuse.

With the above-mentioned structure, the present invention provides the following benefits: 1. The massage base 10 and the rotatable massage unit 30 are connected by the connecting joints 20, and so the rotatable massage unit 30 is able to be rotated around the connecting joint 20; therefore, with different adjustments, the rotatable massage unit 30 can provide a massage to two different leg portions so that the soles, calves and upper legs can all be affected by the massaging movements. 2. The first and second massage airbags 12, 32 have the individual massage regions 121, 321, and with the various inflation sequences of the massage regions 121,321, the first and second massage airbags 12, 32 generate a pressing massage movement and a rubbing massage movement and prevents excessive massaging on a single area of the legs.

Although the present invention has been explained in relation to its preferred embodiment, it is to be understood that many other possible modifications and variations can be made without departing from the spirit and scope of the invention as hereinafter claimed.

What is claimed is:

1. An adjustable leg massager comprising a massage base, two connecting joints and a rotatable massage unit; the massage base having two symmetrical vertical openings at a front face, a plurality of first massage airbags disposed in the openings, and a first cover covering the first massage airbags; a rotatable massage unit having two massaging sections corresponding to the vertical openings of the massage base, a plurality of second massage airbags disposed in the massaging sections, and a second cover covering the second massage airbags;
wherein the two connecting joints comprise an upper joint portion and a lower joint portion pivoted together, the upper and lower joint portions both having a plurality of eyelets, and wherein a stop is disposed at an outer edge of the upper joint portion and adjacent to the pivoted position; and wherein the massage airbags have a plurality of individual massage regions and each massage region is connected with an outlet;
wherein the massage base and the rotatable massage unit are connected together by the connecting joint, and the rotatable massage unit is rotatable using the connecting joint as a rotating axle.

2. The adjustable leg massager as claimed in claim 1, wherein the internal space of the massage base has a tube connected to the massage airbags for deflating and inflating and vibrators at predetermined positions.

3. The adjustable leg massager as claimed in claim 1, wherein the internal space of the rotatable massage unit has tubes connected to the massage airbags for deflating and inflating and vibrators at predetermined positions.

4. The adjustable leg massager as claimed in claim 1, wherein the covers are made of a supple, durable material.

5. The adjustable leg massager as claimed in claim 4, wherein the material is made of leather or cloth.

6. The adjustable leg massager as claimed in claim 1 further comprising a massage pad disposable between the massage airbags and the cover to provide raised bumps on the surface of the cover to enhance massaging results.

7. The adjustable leg massager as claimed in claim 1, wherein the upper joint portions and the lower joint portions of the connecting joints are respectively and closely disposed on the massage base and the rotatable massage unit; wherein the lower joint portions are screwed on a top outer edge of the massage base with the eyelets, and the upper joint portions are screwed onto the bottom outer edge of the rotatable massage unit with the eyelets.

8. The adjustable leg massager as claimed in claim 1, wherein a controller is used for controlling the inflating and deflating operations of the massage airbags, and the controller comprises a remote control.

9. The adjustable leg massager as claimed in claim 1, wherein a controller is used for controlling the inflating and deflating operations of the massage airbags, and the controller comprises a control panel.

10. The adjustable leg massager as claimed in claim 9, wherein the control panel is disposed at a center raised section between the two openings of the massage base.

11. The adjustable leg massager as claimed in claim 9, wherein the control panel is disposed at a center raised section between the two massaging sections of the rotatable massage unit.
